(19) United States
(12) Patent Application Publication
(10) Pub. No.: US 2023/0182418 A1
(43) Pub. Date: Jun. 15, 2023

(54) MOLD FOR PRODUCING A COMPOSITE PART

(71) Applicants: FAURECIA AUTOMOTIVE COMPOSITES, NANTERRE (FR); Institut National des Sciences Appliquées, (US)

(72) Inventors: Thierry RENAULT, DINARD (FR); Jean-Baptiste CASSARD, CHANGE (FR); Elias AMRO, MECE (FR); Afia KOUADRI-HENNI, CORPS NUDS (FR)

(21) Appl. No.: 18/076,606

(22) Filed: Dec. 7, 2022

(30) Foreign Application Priority Data
Dec. 9, 2021 (FR) 21 13211

(51) Int. Cl. B29C 70/78; B29C 70/68; B29C 70/84

(52) U.S. Cl. CPC B29C 70/78; B29C 70/683; B29C 70/84; B29K 2705/00

(57) ABSTRACT

A mold is provided for producing a composite part comprising at least one insert and a thermoplastic overmolding covering, at least partially, said at least one insert. The mold comprises at least one clamp capable of contacting said at least one insert in order to secure said at least one insert.

### CROSS-REFERENCE TO RELATED APPLICATION

This application is a U.S. non-provisional application claiming the benefit of French Application No. 21 13211, filed on Dec. 9, 2021, which is incorporated herein by reference in its entirety.

### TECHNICAL FIELD

The disclosure relates to a mold for producing a composite part.

### BACKGROUND

Producing a composite part by thermoplastic overmolding around an insert is known. For that purpose an insert is placed into a mold. Next, an overmolding material, typically a thermoplastic resin, is injected into the mold, which fills the mold and combines with the insert, thus forming an integral portion of the resulting composite part.

The insert can comprise a metal plate, which is optionally formed, in a known manner.

The insert can comprise an organic sheet in a known manner. An organic sheet is a thermoplastic composite material comprising a fiber mat, providing a structural framework, and a thermoplastic matrix which coats, at least partially, said mat. Such an insert can be used to produce a part with overmolding. The insert is then heated to the melting point of the thermoplastic resin and inserted into a mold in which the overmolding of a thermoplastic compound is injected, optionally reinforced by cut fibers.

An insert can also comprise an organic sheet and a metal plate, advantageously contacting each other.

A problem arises when the overmolding material is injected. Indeed, the injection pressure is so high that it risks causing the insert to move or even deform.

### SUMMARY

Therefore, the disclosure proposes a mold suitable for overcoming this risk of movement or deformation.

For this purpose, the object of the disclosure is a mold for producing a composite part comprising at least one insert and a thermoplastic overmolding covering, at least partially, said at least one insert, the mold comprising at least one clamp capable of contacting said at least one insert in order to secure said at least one insert.

Particular features or embodiments, which may be used alone or in combination, are:

a. an insert comprises an organic sheet or a metal plate,

b. an insert comprises an organic sheet and a metal plate which contacts the organic sheet,

c. a clamp is arranged so as to ensure the position of at least one insert and to enable the insert to withstand the pressure of the overmolding flow,

d. a clamp is arranged at a point of contact between an organic sheet and a metal plate, so as to clamp the organic sheet against the metal plate or the metal plate against the organic sheet,

e. a clamp is arranged at a point of contact between at least two inserts so as to clamp them against each other,

f. a clamp comprises a projection with an axis substantially perpendicular to the insert, the projection having a diametrical extension of between 2.5 and 30 mm, preferably 10 mm,

g. said at least one clamp comprises at least two clamps spaced at a distance of between 15 and 50 mm,

h. at the edge of an insert at least one clamp is arranged, at a distance of between 2.5 and 15 mm from the edge.

In a second aspect of the disclosure, a composite part which comprises at least one insert and a thermoplastic overmolding covering, at least partially, said at least one insert, and is produced by such a mold.

In a third aspect of the disclosure, a method for producing a composite part comprising at least one insert and a thermoplastic overmolding covering, at least partially, said at least one insert, comprising the following steps:—placing said at least one insert into a mold, —closing the mold and—injecting the thermoplastic overmolding material so as to fill the mold, where the mold is a mold according to the first aspect.

Particular features or embodiments, which may be used alone or in combination, are:

i. an insert comprises an organic sheet and a metal plate which contacts the organic sheet, and the method further comprises a preliminary step of texturing the surface of the metal plate which contacts the organic sheet,

j. the texturing comprises narrow stripes and/or at least one flanged perforation.

In a fourth aspect of the disclosure, a composite part which comprises at least one insert and a thermoplastic overmolding covering, at least partially, said at least one insert, and is produced by such a method.

### BRIEF DESCRIPTION OF THE DRAWINGS

The disclosure will be better understood on reading the following description, given solely by way of example, and with reference to the attached figures in which:

FIG. 1 shows a composite part according to the disclosure in front view;

FIG. 2 shows the composite part from FIG. 1 in side view;

FIG. 3 shows a mold according to the disclosure in side view, in relation to a cross section of the composite part from FIG. 1;

FIG. 4 shows a metal plate with texturing by stripes;

FIG. 5 shows a metal plate with texturing by flanged perforations;

FIG. 6, FIG. 7 and FIG. 8 show three steps of overmolding around an organic sheet without using the subject of the disclosure;

FIG. 9, FIG. 10 and FIG. 11 show three steps of the previous overmolding using the subject of the disclosure;

FIG. 12 shows overmolding around an organic sheet and around a metal plate;

FIG. 13 shows another example of overmolding around an organic sheet and around a metal plate without using the subject of the disclosure;

FIG. 14 shows the previous overmolding using the subject of the disclosure;

FIG. 15 shows an assembly using stripe texturing, according to the prior art;

FIG. 16 shows the preceding assembly, according to the disclosure;

FIG. 17 shows an assembly using flanged perforation texturing, according to the prior art;

FIG. 18 shows the preceding assembly, according to the disclosure;

FIG. 19 shows an example of a clamp;

FIG. 20 shows another example of a clamp; and

FIG. 21 shows another example of a clamp.

### DETAILED DESCRIPTION

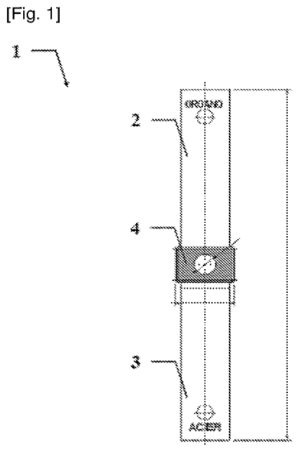

In reference to FIG. 1, the disclosure relates to a composite part 1 which is produced by overmolding. The composite part 1 comprises at least one insert 2, 3 and a thermoplastic overmolding 4 covering, at least partially, said at least one insert 2, 3.

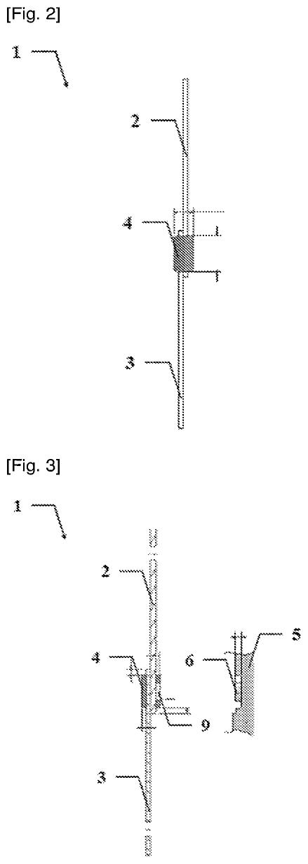

FIGS. 1 to 3 show a part comprising an insert 2, 3 that includes an organic sheet 2 and a contacting metal plate 3. Preferably the organic sheet 2 and the metal plate 3 are assembled via the overmolding 4. The resulting part is in this case a tensile-shear test piece, in order to test the strength of the assembly thus obtained. It is obvious that a composite part 1 according to the disclosure can be of any shape.

The thermoplastic material used for the overmolding 4 is injected into a mold in which the insert 2, 3 has been previously placed. Since the injection is performed at high pressure, it is possible that the insert 2, 3 is moved or even deformed at an injection nozzle. This is detrimental in that the composite part 1 obtained is thus not consistent with the expected result.

In order to remedy this drawback, according to one feature, a mold 5 for producing such a composite part 1 is adapted. The composite part 1 comprises at least one insert 2, 3 and a thermoplastic overmolding 4 covering, at least partially, said at least one insert 2, 3. Adapting the mold 5 includes providing it with at least one clamp 6. Such a clamp 6 is capable of contacting said at least one insert 2, 3 in order to secure it.

An example of such a mold 5 adapted with the addition of a clamp 6 is shown in FIGS. 3, 9-12 and 14.

A clamp 6 contacts said at least one insert 2, 3. This allows the clamp to secure said insert 2, 3 and thus prevent it from moving and/or deforming.

This also creates, in the final part, a gap 9 at the point of contact between the insert 2, 3 and the clamp 6, where the clamp 6 was located, and where the overmolding 4 is absent and does not cover the insert 2, 3.

A gap 9 such as this can however be very small in area, and almost invisible, if a clamp 6 comprises one or more substantially conical tips at its end. It appears that a clamp 6 terminated by three non-aligned tips offers planar support.

The purpose of a clamp 6 is to counter the injection pressure which can cause the insert 2, 3 to move or deform.

According to another feature, an insert 2, 3 comprises an organic sheet 2 or a metal plate 3.

According to another feature, an insert 2, 3 comprises an organic sheet 2 and a metal plate 3. These two components contact each other and the overmolding 4 serves to produce the assembly thereof within the composite part 1.

If an insert 2, 3 comprises an organic sheet 2 and a metal plate 3, according to another feature, a clamp 6 is arranged at the point of contact between the organic sheet 2 and the metal plate 3. Thus, the clamp 6 acts by clamping the organic sheet 2 against the metal plate 3 if the clamp 6 is in contact with the organic sheet 2, or conversely to clamp the metal plate 3 against the organic sheet 2 if the clamp 6 is in contact with the metal plate 3. This allows the two components to remain in contact during the injection and the production of the overmolding 4. This means a much sturdier assembly is possible.

According to another feature, a clamp 6 is arranged at a point of contact between at least two inserts 2, 3 so as to clamp them against each other.

A clamp 6 can be of any shape. According to another feature, a clamp 6 comprises a projection.

The middle axis of this projection is substantially perpendicular to the insert 2, 3 in order to allow the latter to be clamped more effectively. In order to support the injection forces, said projection has an average extension about the axis, in a plane perpendicular to said axis, and which is referred to by default as a diametrical extension, of between 2.5 and 30 mm, preferably 10 mm.

The projection has the function of applying a pressure force on the insert 2, 3. Therefore, the length of the projection must be sufficient to leave only a residual space smaller than the sum of the thickness of the clamped element or elements. This results in stress on the insert or inserts.

Depending on the composite part 1 and its shape, the mold 5 can comprise one or more clamps 6. Each clamp 6 causes an overmolding gap 9, leaving the organic sheet 2 or the metal plate 3 partially visible, and the number of clamps 6 will be limited to the minimum. According to another feature, if there are a plurality of clamps 6, the clamps 6 are spaced apart in pairs by at least a distance of between 15 and 50 mm.

Similarly, more particularly in order to protect the edges of an insert 2, 3, at least clamp 6 is arranged at a distance from said edge of between 2.5 and 15 mm.

The disclosure will now be described by using multiple examples.

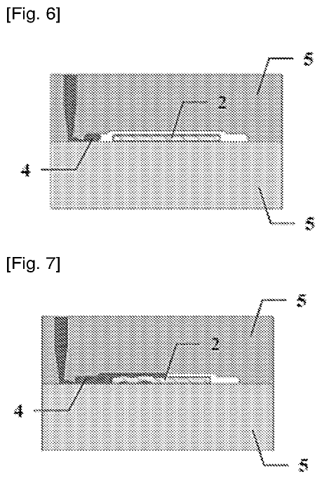

FIGS. 6-8 show, according to the prior art, the production of an overmolding 4 around an insert including an organic sheet 2, in a mold 5, here in two parts. FIG. 6 shows the start of the casting. The mold 5 has been closed and receives an organic sheet 2 preheated to the melting point of its thermoplastic. FIG. 7 shows the overmolding 4 casting material when it meets the organic sheet 2. The latter, softened by heating, is subject to deformation under the effect of the casting pressure. FIG. 8 shows the end of the casting, when the overmolding 4 fully fills the mold 5. The organic sheet 2 remains deformed and thus does not assume the expected position/shape.

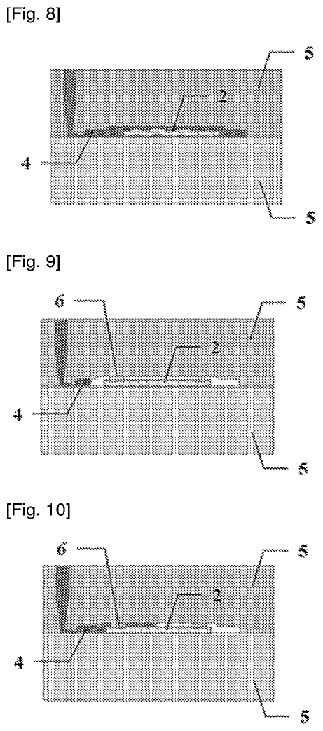

FIGS. 9-11 show the production of the same overmolding 4 according to the disclosure. Clamps 6 have been added to mold 5, so as to clamp said organic sheet 2 against the opposite wall of the mold 5. By doing this, the pressure exerted by the clamps 6 ensures that the organic sheet 2 is secured. FIG. 9 shows the start of the overmolding 4 casting. FIG. 10 shows the next part of the overmolding 4 casting and it is clear that the organic sheet 2 has neither deformed nor moved. FIG. 11 shows the overmolding 4 casting completed, with the organic sheet 2 in the same position and not deformed, as was desired.

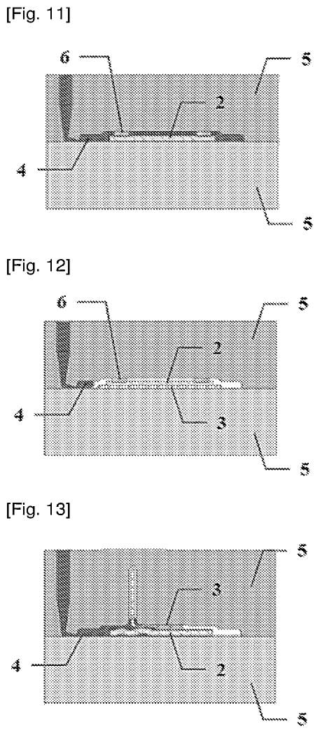

FIG. 12 shows another example. Here the insert comprises a metal plate 3 and an organic sheet 2 placed one on top of the other. Clamps 6 clamp the organic sheet 2 against the metal plate 3 and clamp both against the opposite wall of the mold 5, which ensures that both the metal plate 3 and the organic sheet 2 are secured, thus preventing movement of the metal plate 3 and deformation and/or movement of the organic sheet 2.

FIG. 13 shows, according to the prior art, the production of an overmolding 4 around an insert including an organic sheet 2 and a metal plate 3, in a mold 5, here in two parts. FIG. 3 shows the casting. The mold 5 has been closed and receives an organic sheet 2 preheated to the melting point of its thermoplastic and a metal plate 3 preheated to a temperature slightly higher than the melting point of said thermoplastic of the organic sheet 2. The overmolding 4 casting meets the organic sheet 2 and the metal plate 3. The organic sheet 2, softened by heating, is subject to deformation under the effect of the casting pressure. The metal plate 3 is moved by the deformation of the organic sheet 2, in this case upwards. At the end of the casting, when the overmolding 4 fully fills the mold 5, the organic sheet 2 remains deformed and thus does not assume the expected position/shape and the metal plate 3 is not in its correct position.

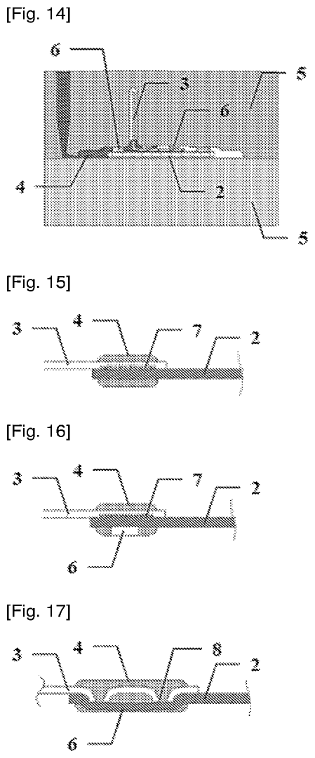

FIG. 14 shows the production of the same overmolding 4, according to the disclosure. Clamps 6 have been added to the mold 5, so as to clamp said organic sheet 2 and/or said metal plate 3 against the opposite wall of the mold 5. By doing this, the pressure exerted by the clamps 6 ensures that the organic sheet 2 and the metal plate 3 are secured. It is clear that the organic sheet 2 has not deformed nor moved and that the metal plate 3 has not moved. At the end of the overmolding 4 casting, the organic sheet 2 is in the correct position and has not deformed, and the metal plate 3 is in the correct position, as was desired.

The disclosure also relates to a composite part 1 which comprises at least one insert 2, 3 and a thermoplastic overmolding 4 covering, at least partially, said at least one insert 2, 3, and is produced by such a mold 5.

The disclosure also relates to a method for producing such a composite part 1. This composite part 1 comprises at least one insert 2, 3 and a thermoplastic overmolding 4 covering, at least partially, said at least one insert 2, 3. The method comprises the following steps. A first step comprises placing said at least one insert 2, 3 into a mold 5. In a following step, the mold 5 is closed. In a following step, the thermoplastic overmolding material 4 is injected under pressure, so as to fill the mold 5. According to one feature, the mold 5 is a mold 5 according to one of the embodiments described above.

If an insert 2, 3 comprises both an organic sheet 2 and a metal plate 3 contacting the organic sheet 2, it is preferable to arrange the organic sheet 2 and the metal plate 3 together. In order to improve this assembly, according to another feature, the metal plate 3 is textured before the insert 2, 3 is placed into the mold 5. This texturing step comprises modifying the surface of the metal plate 3 in order to make it rougher and to allow the thermoplastic matrix of the organic sheet 2 to fill the crevices created by the texturing, thereby creating a mechanical anchor. This texturing relates to the surface of the metal plate 3 which contacts the organic sheet 2.

Such a mechanical anchor is specifically described in EP 3154768. The use of a clamp 6 according to the disclosure ensures contact between the organic sheet 2 and the metal plate 3 and thus achieves the mechanical anchoring effect.

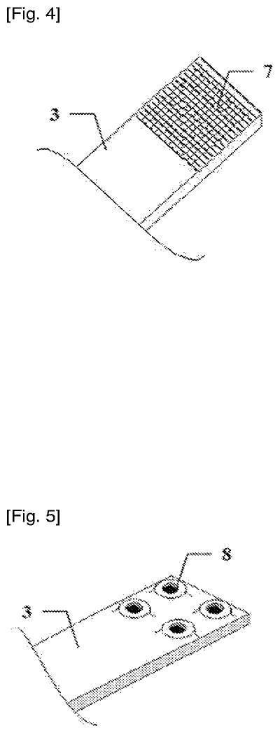

According to another feature, specifically illustrated in FIG. 4, the texturing comprises narrow stripes 7. Such stripes 7 can be produced by any method and more particularly by laser machining. According to another feature, alternative or complementary to the preceding feature, specifically illustrated in FIG. 5, the texturing comprises at least one flanged perforation 8. Such a perforation 8 is produced by any method and more particularly by punching, while ensuring the punched material around the perforation 8 is retained in order to form the flange.

FIG. 15 shows, in a cross-sectional profile view, a part 1 comprising an organic sheet 2, a metal plate 3 which has been previously textured with stripes 7, and an overmolding 4 covering the two, according to the prior art. Despite preheating both the organic sheet 2 and the metal plate 3, it can be observed that the organic sheet 2, or its thermoplastic matrix, does not penetrate said stripes 7.

FIG. 16 shows, in a cross-sectional profile view, the same part 1 as above, comprising an organic sheet 2, a metal plate 3 which has been previously textured with stripes 7, and an overmolding 4 covering the two. However, in this case at least one clamp 6 is added to the mold 5. Said at least one clamp 6 is arranged at the point of contact between the organic sheet 2 and the metal plate 3, so as to clamp the organic sheet 2 against the metal plate 3 and specifically against the stripes 7. In this case, due to the support provided by said at least one clamp 6, it can be observed that the organic sheet 2, via its thermoplastic matrix, deeply penetrates said stripes 7. This clearly contributes to reinforcing the strength of the assembly between the organic sheet 2 and the metal plate 3.

FIG. 17 shows, in a cross-sectional profile view, a part 1 comprising an organic sheet 2, a metal plate 3 which has been previously textured with at least one flanged perforation 8, and an overmolding 4 covering the two, according to the prior art. Despite preheating both the organic sheet 2 and the metal plate 3, it can be observed that the organic sheet 2 and its thermoplastic matrix do not penetrate said perforations 8.

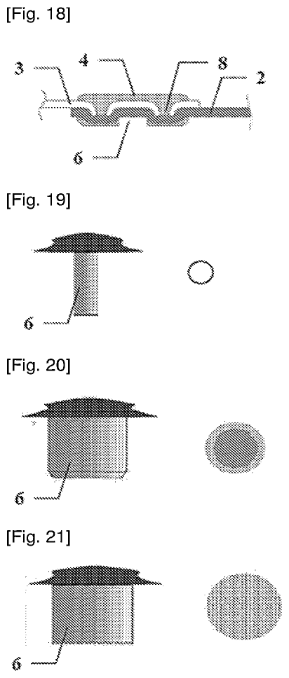

FIG. 18 shows, in a cross-sectional side view, the same part 1 as above, comprising an organic sheet 2, a metal plate 3 which has been previously textured with at least one flanged perforation 8, and an overmolding 4 covering the two. However, in this case at least one clamp 6 is added to the mold 5. Said at least one clamp 6 is arranged at the point of contact the organic sheet 2 and the metal plate 3, so as to clamp the organic sheet 2 against the metal plate 3 and specifically against the flanged perforations 8. In this case, due to the support provided by said at least one clamp 6, it can be observed that the organic sheet 2, via its thermoplastic matrix, is deeply interlocked with said flanged perforations 8. This clearly contributes to reinforcing the strength of the assembly between the organic sheet 2 and the metal plate 3.

Thus, an assembly of an organic sheet 2 and a metal plate 3 provided by an overmolding 4 without a clamp 6 provides a tear resistance of 4 Mpa. On the contrary, an assembly of an organic sheet 2 and a metal plate 3, textured with stripes, provided by an overmolding 4 with a clamp 6 provides a tear resistance of approximately 17 Mpa, i.e. four times greater.

The end of a clamp 6 can vary in shape, size and texture. FIG. 19 shows in a front view, on the left, and in a top view, on the right, a cylindrical clamp 6 with a small diameter. FIG. 20 shows in a front view, on the left, and in a top view, on the right, a cylindrical clamp 6 with a large diameter comprising a chamfer FIG. 21 shows in a front view, on the left, and in a top view, on the right, a cylindrical clamp 6, the clamping end of which has a structure which is this case is gridded.

The disclosure also relates to a composite part 1 obtained by such a method. Said composite part 1 comprises at least one insert 2, 3 and a thermoplastic overmolding 4 covering, at least partially, said at least one insert 2, 3. It is produced by the method according to any of the embodiments described above.

The disclosure has been illustrated and described in detail in the drawings and the preceding description. This should be considered as illustrative and given by way of example and not as limiting the disclosure to this description alone. Many alternative embodiments are possible.

### LIST OF REFERENCE SIGNS

1: composite part,
2: organic sheet,
3: metal plate,
4: overmolding,
5: mold,
6: clamp,
7: stripe,
8: flanged perforation,
9: gap.

1. A mold for producing a composite part comprising:
at least one insert;
a thermoplastic overmolding covering, at least partially, said at least one insert; and
at least one clamp capable of contacting said at least one insert in order to secure said at least one insert.

2. The mold according to claim 1, wherein at least one insert among the at least one insert comprises an organic sheet or a metal plate.

3. The mold according to claim 1, wherein at least one insert among the at least one insert comprises an organic sheet and a metal plate which contacts the organic sheet.

4. The mold according to claim 1, wherein at least one clamp among the at least one clamp is arranged so as to ensure a position of at least one insert among the at least one insert and to enable the at least one insert to withstand the pressure of an overmolding flow.

5. The mold according to claim 4, wherein at least one clamp among the at least one clamp is arranged at a point of contact between an organic sheet and a metal plate, so as to clamp the organic sheet against the metal plate or the metal plate against the organic sheet.

6. The mold according to claim 1, wherein at least one insert comprises a plurality of insert, and wherein at least one clamp among the at least one clamp is arranged at a point of contact between at least two inserts of the plurality of inserts, so as to clamp the at least two inserts against each other.

7. The mold according to claim 1, wherein at least one clamp among the at least one clamp comprises a projection with an axis perpendicular to the at least one insert, the projection having a diametrical extension of between 2.5 and 30 mm.

8. The mold according to claim 7, wherein the projection has a diametrical extension of 10 mm.

9. The mold according to claim 1, wherein said at least one clamp comprises at least two clamps spaced at a distance of between 15 and 50 mm.

10. The mold according to claim 1, wherein at least one clamp among the at least one clamp is arranged at an edge of the at least one insert, at a distance of between 2.5 and 15 mm from the edge.

11. A composite part comprising the at least one insert and the thermoplastic overmolding covering, at least partially, said at least one insert, wherein the composite part is produced by the mold according to claim 1.

12. A production method for producing a composite part comprising the at least one insert and the thermoplastic overmolding covering, at least partially, said at least one insert, comprising the following steps:
placing said at least one insert into the mold according to claim 1,
closing the mold, and
injecting the thermoplastic overmolding material so as to fill the mold.

13. The production method according to claim 12, wherein one insert of the at least one insert comprises an organic sheet and a metal plate which contacts the organic sheet, and wherein the production method further comprises a preliminary step of texturing a surface of the metal plate which contacts the organic sheet.

14. The production method according to claim 13, wherein the texturing comprises narrow stripes and/or at least one flanged perforation.

15. A composite part comprising the at least one insert and the thermoplastic overmolding covering, at least partially, said at least one insert, wherein the composite part is produced by the production method according to claim 12.
